(19) United States
(12) Patent Application Publication
(10) Pub. No.: US 2008/0014495 A1
(43) Pub. Date: Jan. 17, 2008

(54) Membrane Electrode Assembly, Method of Manufacturing the Same, Fuel Battery, and Electronic Device

(76) Inventors: Kotaro Saito, Tenri-shi (JP); Katsumi Teraoka, Yamatokoriyama-shi (JP); Hironori Kambara, Osaka-shi (JP); Tomohisa Yoshie, Nara-shi (JP); Toshiyuki Fujita, Kashihara-shi (JP); Norihiro Ochi, Sakurai-shi (JP)

Correspondence Address: NIXON & VANDERHYE, PC, 901 NORTH GLEBE ROAD, 11TH FLOOR, ARLINGTON, VA, 22203, US

(21) Appl. No.: 11/661,801

(22) PCT Filed: Sep. 12, 2005
(86) PCT No.: PCT/JP05/16717

§ 371 Date: Mar. 1, 2007

(30) Foreign Application Priority Data
Sep. 21, 2004 (JP) 2004-273755

(51) Int. Cl. H01M 8/02

(52) U.S. Cl. 429/44; 427/77

(57) ABSTRACT

There are provided a membrane electrode assembly (1) formed by stacking an extraction electrode (6a, 6b), a catalyst layer (5a, 5b), and an electrolyte membrane (2) in this order and integrating the same, and a method of manufacturing the membrane electrode assembly (1) including the steps of forming an electrode base material by fixing the extraction electrode (6a, 6b) at one surface of a base, forming the catalyst layer (5a, 5b) on the extraction electrode (6a, 6b), and integrating the electrode base material having the catalyst layer (5a, 5b) formed thereon with the electrolyte membrane (2). By such a method, the membrane electrode assembly can be manufactured with high yield, with favorable electrical contact maintained between the catalyst layer and the extraction electrode, without their being pressed and fixed by clamping from outside. Accordingly, it is possible to implement a fuel battery that can produce high output and can be downsized.

### TECHNICAL FIELD

The present invention relates to a membrane electrode assembly for a fuel battery, a method of manufacturing the same, and a fuel battery and an electronic device that use the membrane electrode assembly.

### BACKGROUND ART

A solid Polymer Electrolyte Fuel Cell (hereinafter referred to as “PEFC”), which uses a solid polymer ion-exchange membrane as an electrolyte, has advantages that the electrolyte membrane is a thin membrane, and that its reaction temperature is at most 100° C., which is comparatively lower than that of other fuel cells, and hence no bulky auxiliaries are required. Accordingly, it enables implementation of a small-size fuel battery system. In recent years, the fuel battery has been expected to serve as a next-generation power supply intended to be applied to a motor vehicle or a household appliance. A fuel battery that uses hydrogen as fuel has already entered into the stage where mounting thereof to a motor vehicle is about to be practical. In this case, a high-pressure bottle is mainly used as means for containing fuel (hydrogen).

In contrast, a Direct Methanol Fuel Cell (hereinafter referred to as “DMFC”), which generates electric power by directly extracting a proton from methanol, has advantages that it requires no reformer, and that it uses liquid fuel having a volume energy density higher than that of a gaseous fuel, and hence a methanol fuel container can be made smaller than the high-pressure gas bottle. Accordingly, it attracts attention from the viewpoint that it can be applied to a power supply for a small-size device, particularly from the viewpoint that it can be an alternative to a secondary battery for a portable device.

When the two types of fuel cells described above are to be applied to a portable device, an output voltage per unit cell is at most 1 V. Accordingly, in practical use, it is necessary to connect unit cells in series to stack the same, so as to obtain a desired voltage. As shown in FIG. 10, a conventional solid polymer electrolyte fuel cell ensures a required voltage and electric power by repeatedly stacking the members including an anode collector 105a, an anode catalyst layer 104a, an electrolyte membrane 102, a cathode catalyst layer 104b, and a cathode collector 105b, electrically connecting them in series, sandwiching them by support base materials 107a and 107b from outermost, and screwing a bolt or a nut to press and fix each of the members, in a fuel cell electromotive unit 101. Generally, each of an anode channel plate 106a and a cathode channel plate 106b has a single carbon plate serving as not only a front surface but also a back surface to reduce the number of parts, and obtains favorable electrical conductivity (e.g. Non-Patent Document 1). However, with such a conventional method of ensuring electrical contact by sandwiching the members by support substrates and clamping them by a bolt or a nut from outside to press and fix them, it is significantly difficult to maintain a uniform in-plane pressure all over the stacks and obtain a stable output, as the number of stacks increases.

In contrast, as shown in FIG. 11, Japanese Patent Laying-Open No. 2004-31026 (Patent Document 1) proposes a fuel cell electrode 121 having catalyst layers 125a and 125b, bases 126a and 126b, and collectors 127a and 127b stacked on both sides of an electrolyte membrane 122, respectively, characterized in that collectors 127a and 127b are bonded to bases 126a and 126b, respectively. By doing so, intimate contact is favorably maintained between base 126a and collector 127a, and between base 126b and collector 127b, which makes it possible to electrically connect bases 126a and 126b, and collectors 127a and 127b, respectively. Such a structure eliminates the need of a member such as a support base material, a bolt, or a nut, which member has conventionally been required for engagement and has inhibited downsizing. Accordingly, the fuel cell can be made thin, small, and lightweight.

Patent Document 1: Japanese Patent Laying-Open No. 2004-031026

Patent Document 2: Japanese Patent Laying-Open No. 2001-160406

Patent Document 3: Japanese Patent Laying-Open No. 2003-187810

Non-Patent Document 1: “Development and Application of Solid Polymer Electrolyte Fuel Cell”, NTS Inc., p. 171

### DISCLOSURE OF THE INVENTION

### Problems to be Solved by the Invention

However, in the method described in Patent Document 1, intimate contact between base 126a and collector 127a, and between base 126b and collector 127b is ensured by bonding therebetween, whereas bonding between base 126a and catalyst layer 125a, and between base 126b and catalyst layer 125b is not ensured. Accordingly, there arises a problem of reduced yield in a process of manufacturing a membrane electrode assembly ensuring favorable electrical contact.

Furthermore, in the method described in Patent Document 1, there is adopted a structure where bases 126a and 126b are interposed between catalyst layer 125a and collector 127a, and between catalyst layer 125b and collector 127b, respectively. As a result, there is increased the number of contact interfaces through which a generated electron passes when being extracted to outside of the cell via external output terminals 127a1 and 127b1, and is increased a conductive distance, which causes a problem of increase in resistive loss of an output.

Furthermore, when a piece of carbon paper is used as bases 126a and 126b, as described in the example of Patent Document 1 above, in the state of no pressing force from outside, internal resistance of the carbon paper itself in a plane thickness direction is increased to cause an ohmic loss, which causes a problem of reduction in electric power.

The present invention is made to overcome the problems above. An object of the present invention is to provide a membrane electrode assembly and a method of manufacturing the same. By such a method, the membrane electrode assembly can be manufactured with high yield, with favorable electrical contact maintained between a catalyst layer and an extraction electrode, without their being pressed and fixed by clamping from outside. Accordingly, it is possible to implement a fuel battery that can produce high output and can be downsized. Another object of the present invention is to provide a fuel battery and an electronic device that use the membrane electrode assembly.

### Means for Solving the Problems

The present invention provides a membrane electrode assembly formed by successively stacking a catalyst layer and an extraction electrode at an electrolyte membrane, and integrating the catalyst layer and the extraction electrode with the electrolyte membrane.

Here, it is preferable that the extraction electrode has an opening portion, and that the catalyst layer penetrates into the opening portion. Furthermore, it is preferable that the extraction electrode is formed integrally with the catalyst layer with an adhesion layer interposed therebetween.

The present invention also provides a membrane electrode assembly formed by successively stacking the catalyst layer, the extraction electrode, and a porous substrate at the electrolyte membrane, and integrating the catalyst layer, the extraction electrode, and the porous substrate with the electrolyte membrane. Here, it is preferable that the extraction electrode has an opening portion, and that at least one selected from the group consisting of the porous substrate and the catalyst layer penetrates into the opening portion. Furthermore, it is preferable that the extraction electrode is formed integrally with the catalyst layer with an adhesion layer interposed therebetween.

It is preferable that the porous substrate according to the present invention has electrical conductivity.

It is preferable that the porous substrate according to the present invention has a hydrophobic surface.

In the present invention, it is preferable that the catalyst layer is configured with a first catalyst layer and a second catalyst layer placed in an order allowing the first catalyst layer to be at a larger distance from the electrolyte membrane than the second catalyst layer is, and that the first catalyst layer has a higher void ratio than the second catalyst layer has.

It is preferable that the extraction electrode in the membrane electrode assembly according to the present invention contains at least one element selected from the group consisting of Ti, Au, Ag, Pt, Nb, Ni, Cu, Si, W and Al.

Furthermore, it is preferable that the extraction electrode is either of a metal mesh and a stamped metal plate each having a surface subjected to a conductive, corrosion-resistant treatment.

Furthermore, it is preferable that the extraction electrode according to the present invention is formed by any of an ink jet printing method, a CVD method, a vapor deposition method, a plating method, a sol-gel method, a sputtering method, and a screen printing method.

The present invention also provides a fuel battery having the above-described membrane electrode assemblies according to the present invention arranged in a plane direction and connected electrically. The present invention further provides an electronic device using the fuel battery.

The present invention also provides a method of manufacturing a membrane electrode assembly including the steps of producing an electrode base material by fixing an extraction electrode at one surface of a base; forming a catalyst layer on the extraction electrode; and integrating the electrode base material having the catalyst layer formed thereon with an electrolyte membrane.

In the method of manufacturing the membrane electrode assembly according to the present invention, it is preferable to use a Catalyst Coated Membrane (CCM), which is the electrolyte membrane having a catalyst layer directly transferred thereto.

In the method of manufacturing the membrane electrode assembly according to the present invention, it is preferable to use, as the base, a porous substrate having a hydrophobic layer formed at a surface to be brought into contact with the extraction electrode.

In the method of manufacturing a membrane electrode assembly according to the present invention, it is preferable to use, as the base, a porous substrate having a conductive layer formed at a surface to be brought into contact with the extraction electrode.

The method of manufacturing the membrane electrode assembly according to the present invention preferably includes a step of forming irregularities at least one of a surface of the catalyst layer and a surface of the electrolyte membrane, both of the surfaces being to be bonded together, as a pretreatment of the step of integrating the electrode base material with the electrolyte membrane.

### EFFECTS OF THE INVENTION

With the method of manufacturing the membrane electrode assembly according to the present invention, the extraction electrode and the catalyst layer are adjacent and integrated with each other, and hence even in the state of no pressing force from outside, it is possible to manufacture with high yield a membrane electrode assembly ensuring favorable electrical conductivity between the extraction electrode and the catalyst layer. Furthermore, in the membrane electrode assembly according to the present invention, the extraction electrode serves as a core in the catalyst layer of the membrane electrode assembly, and hence it is possible to produce the catalyst layer having a strength maintained, which catalyst layer has a high void ratio and thus is usually brittle.

Furthermore, the membrane electrode assembly according to the present invention ensures favorable electrical conductivity between the extraction electrode and the catalyst layer even in the case of no pressing force from outside, and hence it is possible to eliminate a site to be clamped by a bolt, which makes it possible to increase an electric power-generating area in the fuel battery, while the fuel battery is made thinner.

### BRIEF DESCRIPTION OF THE DRAWINGS

FIG. 1 is a cross section schematically showing a membrane electrode assembly 1 in a preferable example according to the present invention.

FIG. 2 is an exploded perspective view of membrane electrode assembly 1 shown in FIG. 1.

FIG. 3 is a cross section schematically showing a membrane electrode assembly 11 in another preferable example according to the present invention.

FIG. 4 is a cross section schematically showing a membrane electrode assembly 21 in still another preferable example according to the present invention.

FIG. 5 is a plan view schematically showing a membrane electrode assembly 71 in which a multiple of cells are arranged on a single electrolyte membrane and connected in series to form a circuit.

FIG. 6 is a cross section schematically showing a direct liquid supply fuel battery 70 using membrane electrode assembly 71 in the example shown in FIG. 5.

FIG. 7 is a perspective view schematically showing an example of an electronic device using a fuel battery according to the present invention.

FIG. 8 is a block diagram showing an example of a fuel battery system 77 suitably applied to the present invention.

FIG. 9 is a cross section schematically showing a membrane electrode assembly 31 in a further preferable example according to the present invention.

FIG. 10 is a cross section showing an example of a conventional fuel cell 101.

FIG. 11 is a cross section showing an example of a conventional membrane electrode assembly 121.

### DESCRIPTION OF THE REFERENCE SIGNS

1, 11, 21, 31, 71: membrane electrode assembly, 2: electrolyte membrane, 3, 22, 32: anode electrode, 4, 23, 33: cathode electrode, 5a, 5b, 15a, 15b, 24a, 24b, 25a, 25b, 35a, 35b: catalyst layer, 6a, 6b: extraction electrode, 7a, 7b, 17a, 17b: porous substrate.

### BEST MODES FOR CARRYING OUT THE INVENTION

The membrane electrode assembly according to the present invention is characterized in that it is formed by successively stacking a catalyst layer and an extraction electrode at an electrolyte membrane, and integrating the same with the electrolyte membrane. The term “integrated” herein means the state where members of the membrane electrode assembly do not separate from each other even if they are not pressed from outside, and specifically means the state where they are joined by a chemical bond, an anchor effect, adhesion, or the like. An example of the integrating method includes a method of fusing the electrolyte membrane with the catalyst layer and the extraction electrode by, for example, a hot pressing method. In this case, a polymer binder in the catalyst layer, a polymer binder in a surface of the porous substrate subjected to a hydrophobic treatment, or the like is deformed by heat during hot pressing, so that a three-dimensional anchor effect ensures joint. With the membrane electrode assembly having such a structure and according to the present invention, it is possible to favorably maintain electrical contact between the extraction electrode and the catalyst layer, without their being sandwiched by the support base materials, and their being clamped with a bolt or a nut to exert an external pressure. Furthermore, in the membrane electrode assembly according to the present invention, the extraction electrode and the catalyst layer are always adjacent to each other, and hence it is possible to significantly lower the probability of poor contact during the manufacturing process.

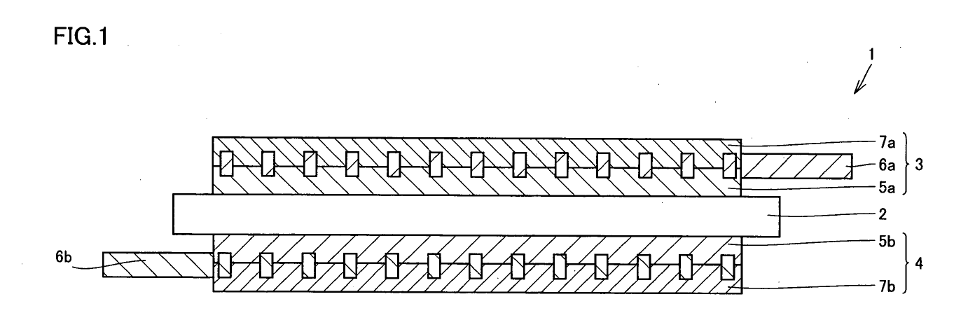

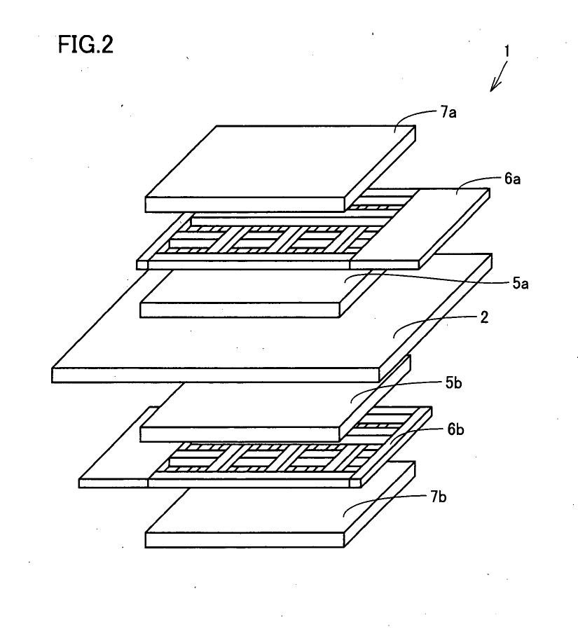

FIG. 1 is a cross section schematically showing a membrane electrode assembly 1 in a preferable example of the present invention. FIG. 2 is an exploded perspective view of membrane electrode assembly 1 shown in FIG. 1. For example, as shown in FIG. 1, membrane electrode assembly 1 according to the present invention has a structure in which an anode electrode 3 and a cathode electrode 4 are arranged with an electrolyte membrane 2 interposed therebetween. Electrolyte membrane 2 is formed of an appropriate, conventionally-known polymer membrane, inorganic membrane, or composite membrane. Examples of the polymer membrane include a perfluorosulfonic acid-based electrolyte membrane (Nafion (from DuPont), a Dow membrane (from the Dow Chemical Company), Aciplex (from Asahi Kasei Corporation), Flemion (from ASAHI GLASS CO., LTD.)) and a hydrocarbon-based electrolyte membrane such as polystyrene sulfonic acid or sulfonated polyether ether ketone. Examples of the inorganic membrane include phosphate glass, cesium hydrogensulfate, polytungstophosphoric acid, polyammonium phosphate, and others. Examples of the composite membrane include a GORE-SELECT membrane (from W. L. Gore & Associates, Inc.), a pore-filling electrolyte membrane, and others.

Anode electrode 3 in membrane electrode assembly 1 includes a catalyst layer (anode catalyst layer) 5a, an extraction electrode 6a, and a porous substrate 7a successively stacked at electrolyte membrane 2. Fuel is supplied to anode electrode 3 through a fuel storage container (not shown). Examples of the method of supplying fuel include a method of allowing liquid fuel in the fuel storage container to freely drip therefrom, a method of utilizing a capillary force of porous substrate 7a to draw fuel from the fuel storage container, a method of vaporizing liquid fuel to supply the same in the form of steam, and other methods. For the liquid fuel, it is possible to use organic fuel containing a hydrogen atom, such as methanol, Dimethyl Ether (DME), or formic acid, or composite liquid fuel mixed with gas or various types of liquids.

As in anode electrode 3, cathode electrode 4 in membrane electrode assembly 1 includes a catalyst layer (cathode catalyst layer) 5b, an extraction electrode 6b, and a porous substrate 7b successively stacked at electrolyte membrane 2. Oxygen in the air is supplied to cathode electrode 4 as an oxidizing agent. Examples of the method of supplying the air include a method of opening the cathode electrode to the atmosphere, a method of supplying the air through a filter by a blower fan or a blower pump, and other methods.

The membrane electrode assembly according to the present invention is preferably formed by stacking the catalyst layer, the extraction electrode, and the porous substrate at the electrolyte membrane, and integrating the same with the electrolyte membrane. Furthermore, in such a configuration, it is preferable that the extraction electrode has an opening portion as described below, and that at least one selected from the group consisting of the porous substrate and the catalyst layer penetrates into the opening portion. Here, the “penetrating” state refers to the state where at least one of the catalyst layer and the porous substrate is embedded in the opening portion of the extraction electrode. With the membrane electrode assembly having such a structure and according to the present invention, the extraction electrode serves as a support material of the membrane electrode assembly, and hence it is possible to improve dimensional stability. Furthermore, when the catalyst layer penetrates into the opening portion of the extraction electrode, the extraction electrode serves as a core in the catalyst layer, which makes it possible to increase a strength of the catalyst layer. Furthermore, a contact area between the extraction electrode and the catalyst layer is increased, which reduces contact resistance. Additionally, increase in bonded area improves adhesiveness, which makes it possible to prevent peeling. Moreover, when the porous substrate penetrates into the opening portion of the extraction electrode, a distance between the porous substrate and the catalyst layer is decreased, and hence transfer of fuel and transfer of produced emissions between both of the layers are facilitated. FIG. 1 shows an example in which extraction electrode 6a of anode electrode 3 is embedded in catalyst layer 5a and porous substrate 7a, while extraction electrode 6b of cathode electrode 4 is embedded in catalyst layer 5b and porous substrate 7b. Although FIG. 1 shows the configuration having the porous substrate, there may also be adopted a configuration not having the porous substrate.

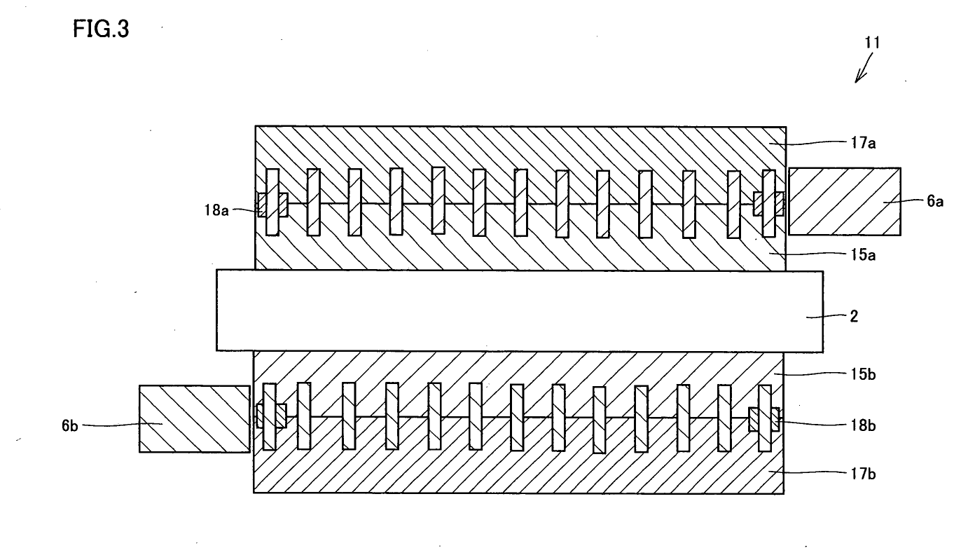

FIG. 3 schematically shows a membrane electrode assembly 11 in another preferable example of the present invention. Membrane electrode composite 11 in an example shown in FIG. 3 has a configuration similar to that of the membrane electrode assembly 1 shown in FIG. 1, except that an adhesion layer 18a is formed between a catalyst layer 15a and an extraction electrode 6a and between catalyst layer 15a and porous substrate 17a, and an adhesion layer 18b is formed between a catalyst layer 15b and an extraction electrode 6b and between catalyst layer 15b and porous substrate 17b, so that a portion having a similar configuration is provided with the same reference character for illustration. When adhesion layers 18a and 18b are to be formed, it is preferable to use an adhesive predominantly composed of an organic polymer that does not use a metal-based compounding agent, a sulfur compound, or a volatile organic compound, as a cross-linking agent or a plasticizing agent, in order to suppress elution of cations and the like. For example, it is possible to use an adhesive predominantly composed of a silicone resin, an epoxy resin, an olefin resin, or a fluorine-based resin each having heat resistance and water resistance. With the membrane electrode assembly having such a structure, a binder in the adhesion layer has cohesion to carbon in the catalyst layer and to the extraction electrode (e.g. metal), and hence adhesive strength between the catalyst layer and the extraction electrode is increased, which makes it possible to prevent peeling. More preferable example of the adhesion layer is a conductive porous layer formed of an adhesive in which a conductive substance (e.g. a carbon particle) is kneaded.

In membrane electrode assemblies 1 and 11 in the examples shown in FIGS. 1 and 3, electrons obtained through an electric power generating reaction at catalyst layers 5a and 15a in the anode electrode are collected at extraction electrode 6a and extracted to outside. Catalyst layer 5a and extraction electrode 6a, and catalyst layer 15a and extraction electrode 6a, are adjacent with each other and integrated, and hence implement favorable electrical connection even in the state of no pressing force from outside. Accordingly, it is possible to significantly lower a resistance value between catalyst layer 5a and extraction electrode 6a, and between catalyst layer 15a and extraction electrode 6a, which causes improvement in electric power generation efficiency. The electrons extracted to an external circuit from extraction electrode 6a are supplied through extraction electrode 6b to catalyst layers 5b and 15b, so that the electrons are used in reaction. Accordingly, it is also possible to lower an electric resistance value in extraction electrode 6b and catalyst layers 5b and 15b, which makes it possible to improve electric power generation efficiency. Furthermore, there occur no variations in in-plane pressure that would have been caused by the conventional pressing method, so that stable electric power generation is possible.

For catalyst layers 5a, 5b, 15a and 15b used for membrane electrode assemblies 1 and 11 in the examples shown in FIGS. 1 and 3, it is possible to use, for example, a layer containing a catalyst-carrying carbon particle and a microparticle of the solid polymer electrolyte membrane. Examples of the catalyst above include, for example, precious metals such as Pt, Ru, Au, Ag, Rh, Pd, Os and Ir, and base metals such as Ni, V, Ti, Co, Mo, Fe, Cu and Zn. In the present invention, each of them may be used alone or at least two types of them may be used in combination. Note that catalyst layers 5a, 5b, 15a and 15b are not necessarily limited to the ones of the same type, and that different materials may be used therefor.

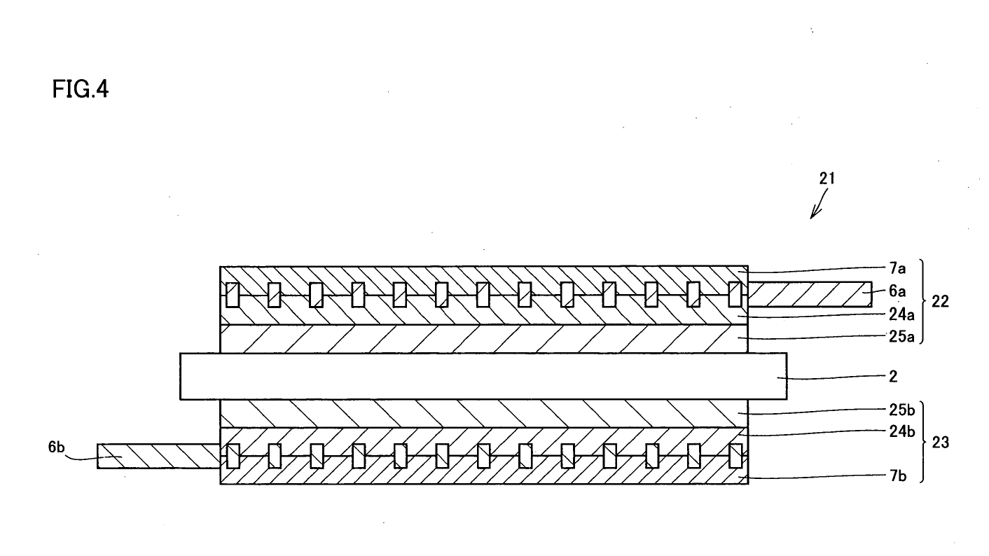

FIG. 4 schematically shows a membrane electrode assembly 21 in another preferable example of the present invention. Membrane electrode assembly 21 in the example shown in FIG. 4 has a configuration similar to that of membrane electrode assembly 1 in the example shown in FIG. 1, except that catalyst layers are configured with first catalyst layers 24a and 24b, and second catalyst layers 25a and 25b, respectively, that first catalyst layer 24a is formed to have a higher void ratio than second catalyst layer 25a has, and that first catalyst layer 24b is formed to have a higher void ratio than second catalyst layer 25b has, and hence a portion having a similar configuration is provided with the same reference character for illustration.

One of the examples in a suitable mode of the membrane electrode assembly according to the present invention can be a membrane electrode assembly having a structure formed by successively stacking the second catalyst layer, the first catalyst layer, the extraction electrode, and the porous substrate at the electrolyte membrane, and integrating the same with the electrolyte membrane, the first catalyst layer being formed to have a higher void ratio than the second catalyst layer has. In the example shown in FIG. 4, an anode electrode 22 includes second catalyst layer (second anode catalyst layer) 25a, first catalyst layer (first anode catalyst layer) 24a, extraction electrode 6a, and porous substrate 7a successively stacked at electrolyte membrane 2. A cathode electrode 23 similarly includes second catalyst layer (second cathode catalyst layer) 25b, first catalyst layer (first cathode catalyst layer) 24b, extraction electrode 6b, and porous substrate 7b successively stacked at electrolyte membrane 2.

For first catalyst layers 24a and 24b, there are used layers formed to have a higher void ratio than second catalyst layers 25a and 25b have, which makes it possible to improve fuel diffusivity in the catalyst layer immediately below the extraction electrode, to increase an area of a three-phase interface to which fuel is supplied, and to reduce variations in in-plane electric power generation, so that a high output can stably be generated. Furthermore, the extraction electrode serves as a core in the catalyst layer, and hence the catalyst layer having a high void ratio, which layer would generally be brittle, can be formed with a certain strength maintained.

First catalyst layers 24a and 24b, and second catalyst layers 25a and 25b in the example shown in FIG. 4 may be formed of materials identical with, or different from one another, the materials being selected from the ones shown above. If the catalyst layers are formed of the same material, a component ratio of the material and a drying condition of a solvent for each of the catalyst layers are modified so that the catalyst layers are formed to have void ratios different from one another. The first catalyst layer has an effect of an adhesive that increases an adhesive strength between the extraction electrode and the second catalyst layer, which makes it possible to prevent peeling. As long as there is maintained a relationship in which first catalyst layers 24a and 24b have higher void ratios than second catalyst layers 25a and 25b have, void ratios of first catalyst layers 24a and 24b, and second catalyst layers 25a and 25b are not particularly limited. However, it is preferable that void ratios of first catalyst layers 24a and 24b fall within a range of 30-45%, while void ratios of second catalyst layers 25a and 25b fall within a range of 20-35%. Note that the void ratio of each of first catalyst layers 24a and 24b, and second catalyst layers 25a and 25b refers to a measured value obtained by impregnating the membrane electrode assembly with an embedding epoxy resin (from Okenshoji Co., Ltd.), drying the membrane electrode assembly at a room temperature for 12 hours, subsequently cutting the same to obtain a section of the catalyst layer thereof, observing the section by means of a scanning electron microscope JSM-5000 (from JEOL Ltd.) at an accelerating voltage of 10 kv and at 4000-fold magnification, scanning the obtained SEM photograph by a scanner, using analysis software (Image-Pro PLUS from Planetron, Inc.) for binarization, and performing image processing for calculating an area ratio.

In any of membrane electrode assemblies 1, 11 and 21 in respective modes shown in FIGS. 1, 3 and 4, a metal can be used for extraction electrodes 6a and 6b, so that specific resistance of the extraction electrode itself can be made small. Extraction electrodes 6a and 6b preferably include at least one element selected from the group consisting of, for example, Ti, Au, Ag, Pt, Nb, Ni, Cu, Si, W and Al, and more preferably include at least one element selected from the group consisting of Au, Cu, Ni and W. This is because when the element above is contained therein, specific resistance of the extraction electrode itself becomes small, which makes it possible to reduce a resistive loss of the extraction electrode.

For extraction electrodes 6a, 6b according to the present invention, there is preferably used a metal mesh or a stamped metal plate each having a surface subjected to a conductive, corrosion-resistant treatment. The conductive, corrosion-resistant treatment can be performed by coating surfaces of extraction electrodes 6a and 6b with a precious metal such as Au, Ag or Pt. By performing the conductive, corrosion-resistant treatment, lifetime of the membrane electrode assembly can be prolonged. Furthermore, by using the metal mesh or the stamped metal plate, an opening portion for supplying to the catalyst layers fuel and air, which have been supplied through porous substrates 7a, 7b, 17a and 17b, can be provided at extraction electrodes 6a and 6b in a plane thickness direction. Accordingly, it is possible to reduce inhibition of liquid fuel supply and gaseous fuel supply in the extraction electrodes in a plane thickness direction, and efficiently collect electric power.

Extraction electrodes 6a and 6b according to the present invention are not limited to the ones described above, and it is possible to use the one formed by the conventional, known, thin membrane-forming technique. For example, an extraction electrode formed by an ink jet printing method, a CVD method, a vapor deposition method, a plating method, a sputtering method, or a screen printing method is suitable because it can implement an extremely fine electrode with a small line width and hence improve fuel diffusivity to the catalyst layer.

Although an opening ratio of each of extraction electrodes 6a and 6b is not particularly limited, it is preferably set to be at least 10%, and more preferably set to be at least 40%. By setting the opening ratio to be at least 10%, it is possible to ensure a large area where fuel and air are diffused, which makes it possible to efficiently supply fuel to a reaction field. Furthermore, an opening ratio of each of extraction electrodes 6a and 6b is preferably set to be at most 95%, and more preferably set to be at most 90%. This is because, by setting the opening ratio to be at most 95%, it is possible to decrease a distance along which a generated electron moves in an in-plane direction in catalyst layer 5a, which has a higher specific resistance than extraction electrode 6a has, before the electron is extracted from extraction electrode 6a, and to reduce a resistive loss. Furthermore, when the electron extracted to an external circuit from extraction electrode 6a moves to catalyst layer 5b through extraction electrode 6b, it is also possible to reduce a resistive loss. As to resistance R of a bar-like object having a length L and a sectional area S, an expression R=ρ·L/S (ρ: resistivity) is established. Accordingly, given that a minimum line width of extraction electrodes 6a and 6b in an in-plane direction is w, and a thickness in a plane thickness direction is d, the larger sectional area S=w·d can make a resistive loss smaller. The smaller minimum line width w can offer larger improvement in diffusivity of fuel, which streams around the electrode and down into the catalyst layer immediately below the electrode, and hence can increase an active catalyst area, which makes it possible to stably produce a high output. Accordingly, the extraction electrode is preferably shaped such that it has a small line width w and a large thickness d, and hence a high aspect ratio.

The porous substrate according to the present invention is not necessarily an essential configurational requirement, so that a membrane electrode assembly formed by stacking an extraction electrode, a catalyst layer, and an electrolyte membrane in this order and integrating the same is also embraced in the scope of the present invention. Here, “porous” refers to a base having a porosity of at least 5% (preferably at least 30%). The porosity of the porous substrate can be calculated by, for example, measuring a volume and a weight of the porous substrate, determining a specific gravity of the porous substrate, and substituting the specific gravity of the porous substrate and a specific gravity of a raw material in the following expression.
Pore Ratio(%)=(1−(Specific Gravity of Porous Substrate/Specific Gravity of Raw Material))×100
The use of such a porous substrate offers an advantage that porous substrates 7a and 17a in the anode electrode have capillary force, and hence particularly in the case where liquid fuel is used, efficient fuel supply becomes possible.

For porous substrates 7a, 7b, 17a and 17b, there may be used a conductive one such as a foam metal, a carbon mold, or a ceramic mold, or a non-conductive one such as a fiber bundle or a polymer mold. Alternatively, there may be used a non-conductive porous substrate where a conductive layer that does not inhibit fluid permeation is formed at the surface. The use of conductive ones as porous substrates 7a, 7b, 17a and 17b offers an advantage that porous substrates 7a and 17a are allowed to have a function of assisting in electron collection from catalyst layers 5a and 15a in extraction electrodes 6a and in electrical conduction in a lateral direction, which makes it possible to reduce a resistive loss. Furthermore, porous substrates 7b and 17b are also allowed to have a function of assisting in electron supply to catalyst layers 5b and 15b in extraction electrode 6b and in electrical conduction in a lateral direction, which makes it possible to obtain a similar effect. Porous substrates 7a, 7b, 17a and 17b may also be formed of a kneaded paste containing at least a conductive powder and a binder, as constituent materials.

The porous substrate of the membrane electrode assembly according to the present invention may be implemented such that the surface thereof has water repellency. If a surface of the porous substrate to be joined to the extraction electrode has water repellency, a pore in the porous substrate is prevented from being clogged with a liquid, and hence efficient gas supply and gas ejection become possible in the catalyst layer. It is thereby possible to increase an active catalyst area in the catalyst layer and improve its characteristic. Water repellency can be provided at the surface of the porous substrate by, for example, forming a hydrophobic layer containing PolyTetraFluoroEthylene (PTFE) thereat.

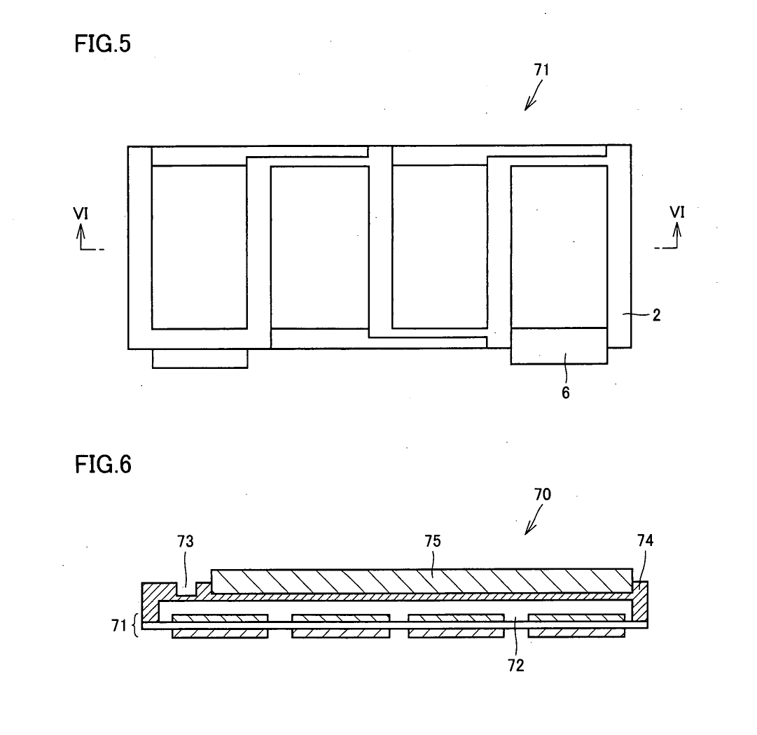

Next, a fuel battery using the membrane electrode assembly according to the present invention will be described, with direct liquid supply fuel battery taken as an example. FIG. 5 is a plan view of a membrane electrode assembly 71, in which a multiple of cells are arranged on a single electrolyte membrane 2 and connected in series. FIG. 6 is a schematic cross section of a direct liquid supply fuel battery 70 using membrane electrode assembly 71 in the example shown in FIG. 5. Note that a portion of membrane electrode assembly 71 in FIG. 6 is shown in a cross section taken along a cutting plane VI-VI in FIG. 5. In membrane electrode assembly 71 in the example in FIG. 5, anode electrodes of all the cells on electrolyte membrane 2 are placed at one surface of electrolyte membrane 2, and hence fuel can be transmitted to all the electrodes simultaneously, which makes it possible to downsize a fuel supply mechanism. In fuel battery 70 in the example shown in FIG. 6, a cover casing 74 provided with a fuel supply space 72 and an exhaust hole 73 is installed on an anode side of membrane electrode assembly 71, and liquid fuel in a liquid fuel tank 75 is supplied to fuel space 72. Cover casing 74 is joined to an outer peripheral portion of membrane electrode assembly 71 with a sealing property ensured, so as not to allow the liquid fuel to flow outwardly.

In fuel battery 70 in the example shown in FIG. 6, a wicking material is preferably provided at fuel supply space 72 for efficient fuel diffusion and supply. The wicking material is required to have fuel resistance and acid resistance. For example, it is possible to use a nonwoven fabric such as polyethylene, polyethylene telephthalate, polypropylene, or polyphenyl sulfide. By maintaining a state allowing both of the anode electrode of the electric power generating cell in the fuel battery and the liquid fuel to be brought into contact with the wicking material, it is possible to avoid a situation in which a plane among planes of the catalyst layer fails to be in contact with the fuel, which situation could occur depending on a liquid level in the fuel supply space, based on an installation direction of the fuel battery. Exhaust port 73 has a function of ejecting carbon dioxide generated. In order to prevent outward leakage of liquid, a gas-liquid separation membrane is preferably used for exhaust port 73. The generated carbon dioxide passes through the fuel supply space or the wicking material to be ejected through exhaust port 73.

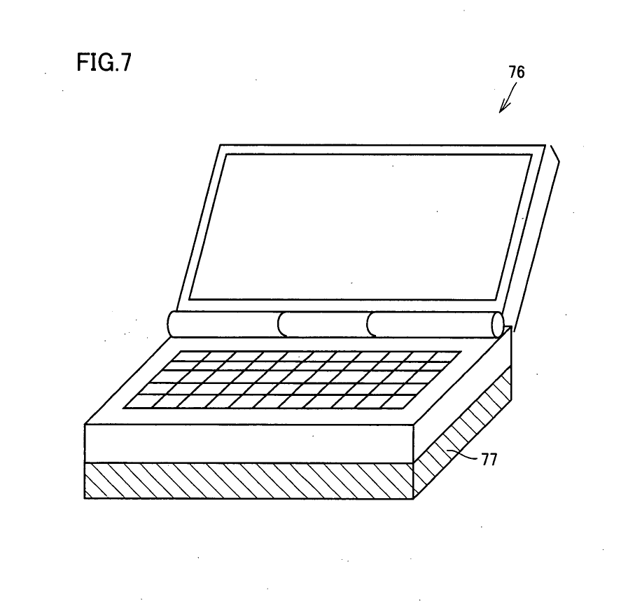

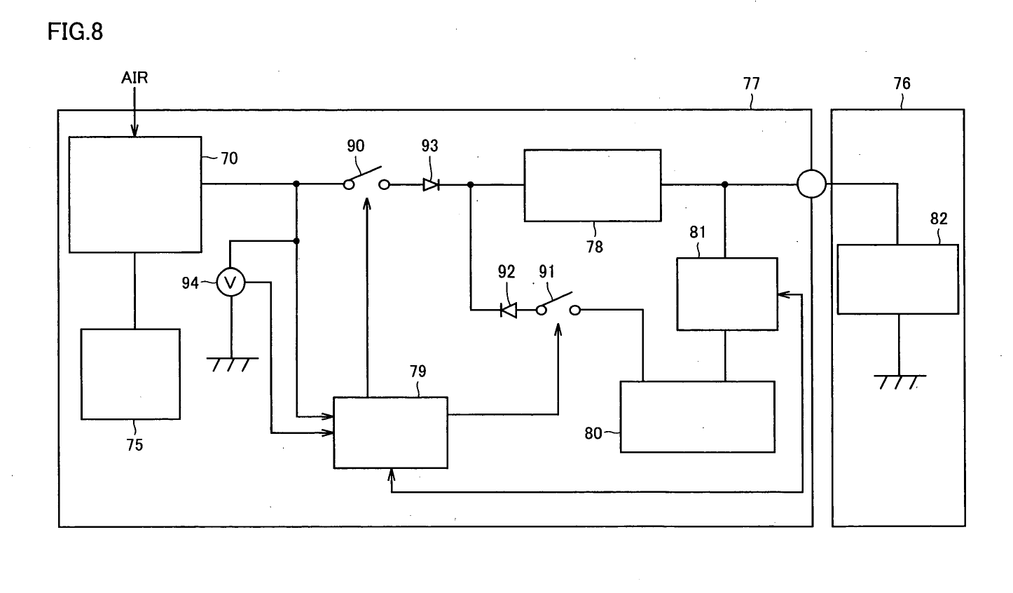

FIG. 7 schematically shows an example of an electronic device 76 using the fuel battery according to the present invention. FIG. 8 is a block diagram showing an example of a fuel battery system 77 in electronic device 76 in the example shown in FIG. 7. In electronic device 76 according to the present invention, fuel battery system 77 is configured with, for example, fuel battery 70, liquid fuel tank 75, a DC/DC converter 78, a control circuit 79, a secondary battery 80, and a charge control circuit 81. In the drawing, liquid fuel tank 75 is included as a component of the fuel battery system. However, as another mode, liquid fuel tank 75 may also be attached to an outside of a fuel battery system including no liquid fuel tank. A capacitor may be used instead of secondary battery 80.

Fuel battery 70 generates electric power by taking in liquid fuel from liquid fuel tank 75 and air (oxygen) from an atmosphere. Fuel battery 70 is electrically connected in series to an electronic device load 82, while an extracted voltage is stepped up to, or stepped down to a voltage desired for the electronic device load, by DC/DC converter 78. Diodes 92 and 93 prevent backflow of current, so that there is adopted a hybrid control in which, when a voltage of secondary battery 80 is higher than a voltage at electric power generation by the fuel battery, more current is allowed to flow from the secondary battery side. Moreover, fuel battery system 77 may further have a fuel battery voltage detector 94 for detecting a voltage at electric power generation by the fuel battery. When fuel battery voltage detector 94 detects that a detected voltage at the fuel battery is lower than a certain set threshold at a pulse-like peak current, for example, a switch 90 is turned off and a switch 91 is turned on, which enables control that allows the secondary battery or the capacitor to assist an output. Charge control circuit 81 controls charging of the secondary battery while detecting a remaining capacity of the secondary battery.

Membrane electrode assembly 71 according to the present invention requires no pressure plate having a desired thickness or a clamping structure by a bolt, and hence it is possible to form a thin fuel battery ensuring a favorable output. Furthermore, in the fuel battery according to the present invention, the cover casing does not need to have a large stiffness, and hence can be made thin.

A method of manufacturing the membrane electrode assembly according to the present invention is not particularly limited, as long as the membrane electrode assembly has the structure described above. However, the membrane electrode assembly is preferably manufactured by a method of manufacturing a membrane electrode assembly according to the present invention. In other words, the present invention provides a method of manufacturing a membrane electrode assembly including a step (1) of producing an electrode base material by fixing an extraction electrode at one surface of an base (an electrode base material producing step), a step (2) of forming a catalyst layer on the extraction electrode (a catalyst layer forming step), and a step (3) of integrating the electrode base material having the catalyst layer formed thereon with an electrolyte membrane (an integrating step). With such a method of manufacturing a membrane electrode assembly according to the present invention, it is possible to provide with high yield a membrane electrode assembly in which the extraction electrode and the catalyst layer are adjacent, and favorable electrical contact is ensured without any pressing force from outside.

In the method of manufacturing a membrane electrode assembly according to the present invention, the base may be peeled off after the membrane electrode assembly is produced, or may remain in an integrated state without being peeled off. An easily-peeled base such as a sheet made of PTFE is preferably used in the former case, while a porous substrate allowing fuel and air permeation is preferably used in the latter case.

For the electrode base material producing step (1), it is possible to adopt, for example, a method of embedding a metal mesh into a base by a pressure force. This method can be performed at a normal temperature and requires no complicated steps, which makes it possible to keep low the cost required for the electrode base material producing step.

If a porous substrate is used for the base, a hydrophobic layer containing PTFE, for example, may be formed in advance on the same surface of the porous substrate where the extraction electrode is to be fixed. By doing so, it is possible to provide a membrane electrode assembly that can implement a porous substrate provided with water repellency at its surface, and that has a structure preventing the porous substrate from being clogged with a liquid, and providing efficient gas supply and gas ejection.

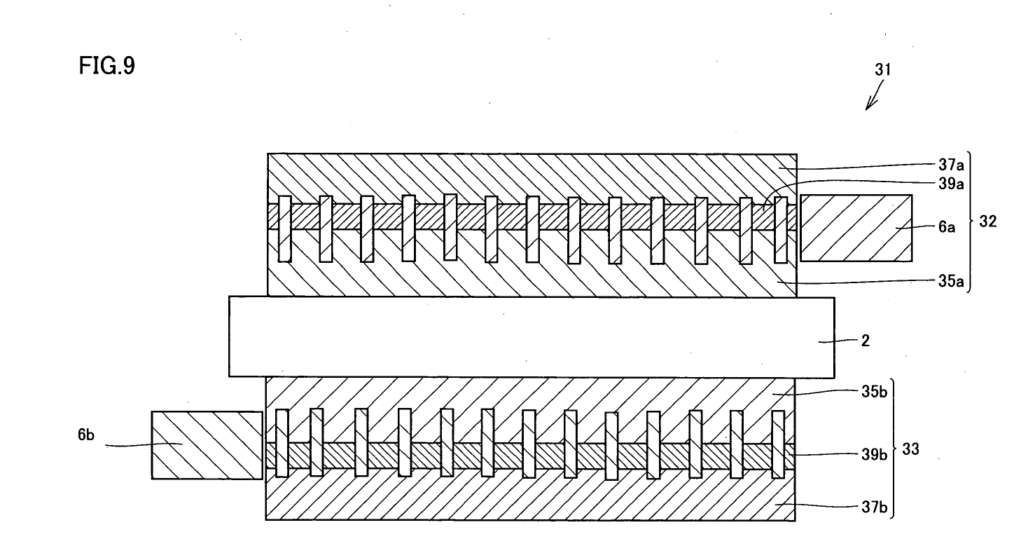

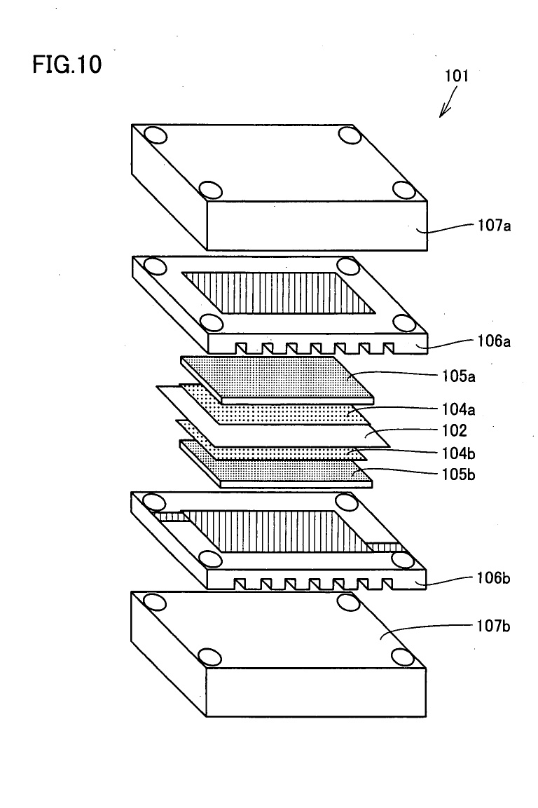

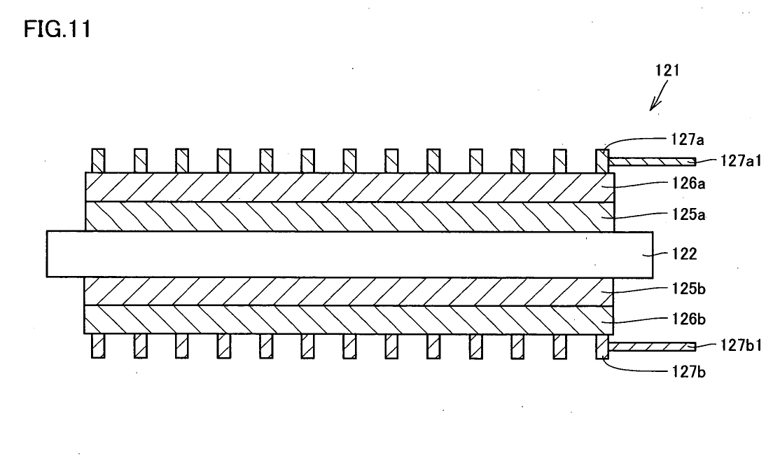

If a porous substrate is used for the base, it is preferable to use a porous substrate having a conductive layer formed thereat while an opening property that allows fuel or air permeation is ensured at one surface. FIG. 9 schematically shows a membrane electrode assembly 31 in another preferable example of the present invention. Membrane electrode assembly 31 in the example in FIG. 9 is similar to membrane electrode assembly 1 shown in FIG. 1, except that conductive layers 39a and 39b are formed at surfaces of porous substrates 37a and 37b, which surfaces are to be brought into contact with extraction electrodes 6a and 6b, respectively. Accordingly, a portion having a similar configuration is provided with the same reference character for illustration. By using such a porous substrate and fixing the extraction electrode on the same surface, it is possible to provide membrane electrode assembly 31 having a structure in which conductive layer 39a on porous substrate 37a has a function of assisting, in an anode electrode 32, in electron collection from catalyst layer 35a in extraction electrode 6a and in electrical conduction in a lateral direction, and which can reduce a resistive loss. For a cathode electrode 33, a similar effect can also be obtained.

Alternatively, as the electrode base material producing step (1), the electrode base material may be produced by bonding the porous substrate and the extraction electrode with an adhesion layer provided therebetween. The adhesion layer preferably has electrical conductivity and water repellency, and may be formed with the use of a liquid made of, for example, carbon particles, PTFE, and a solvent (e.g. water), the liquid allowing hydrophobic-treated carbon black to be dispersed therein. When the porous substrate and the extraction electrode are to be integrated, the electrode base material impregnated with the dispersed liquid above is kept at approximately 110-120° C. to dry a coating, and heated in an electric furnace at 360° C. for at least 30 minutes, so that the porous substrate and the extraction electrode can be bonded together while water repellency is provided thereto.

An example of the electrode base material producing step (1) includes a method of forming an electrode pattern by producing a patterning mask on the porous substrate, then generating a thin membrane by a CVD method, a PVD method, a sol-gel method, an electroplating method or the like, and peeling off the mask. An example of a mask producing technique is a photolithography method. Examples of the thin membrane forming technique include, for example, a normal pressure CVD method, a plasma CVD method, a sputtering method, a vacuum vapor deposition method, a surface polymerization method, a sol-gel method, an electroplating method and the like. With these methods, it is possible to form a fine electrode pattern having a line width of approximately at most 10 μm. Accordingly, by forming an extraction electrode having a high opening ratio and a high aspect ratio, it is possible to provide a membrane electrode assembly exhibiting high fuel diffusivity, a high electric power-collecting property, and high electrical conductivity. Alternatively, an ink jet printing method is suitable as another method because it eliminates the need of using a mask, simplifies the steps, and enables formation of an extremely fine electrode pattern.

In the catalyst layer forming step (2), a slurry made of a catalyst-carrying conductive powder, an electrolyte and a solvent mixed therein, for example, is applied to a side of the electrode base material, where the extraction electrode is fixed, and then the solvent is removed. Examples of the catalyst include a precious metal such as Pt, Ru, Au, Ag, Rh, Pd, Os or Ir, or a base metal such as Ni, V, Ti, Co, Mo, Fe, Cu or Zn. In the present invention, each of them can be used alone or at least two types of them can be used in combination. For the conductive powder, it is possible to use a carbon powder such as acetylene black, ketjen black, furnace black, carbon nanotube, carbon nanohorn, or backminster-fullerene. For the electrolyte, it is possible to use, for example, a polymer electrolyte solution such as Nafion (from DuPont) or Flemion (from ASAHI GLASS CO., LTD.). For the solvent, it is possible to use, for example, ethylene glycol dimethyl ether, n-butyl acetate, or a lower alcohol such as isopropanol. A carbon powder having PTFE added thereto to obtain water repellency, or ethylene glycol serving as a viscosity adjuster may also be added. A specific composition of the slurry is not particularly limited. However, if a precious metal catalyst-carrying carbon powder, a polymer electrolyte solution, and a diluent solvent are mixed, there is illustrated a case where Pt/C, a Nafion (R) solution, an organic solvent are mixed at distribution rates of 2 mg Pt/cm², 1.0 mg/cm², 60 mg/cm², respectively, with respect to a certain electrode area, for adjustment. The slurry is uniformly applied, by means of a bar coater, by a screen printing method or the like, to a surface of the electrode base material where the extraction electrode is fixed, the electrode base material being produced in the electrode base material producing step (1), and the diluent solvent in the slurry is removed to form a catalyst layer.

In the integrating step (3), a hot pressing method is an example of the method of integrating the electrode base material having the catalyst layer formed thereon with the electrolyte membrane. At hot pressing, the surface where the catalyst layer is formed and the electrolyte membrane are arranged such that they are brought into contact with each other. A condition at hot pressing is selected depending on materials, and it is possible to adopt, for example, a temperature exceeding a softening temperature or a glass transition temperature of the electrolyte membrane or a polymer electrolyte membrane in the catalyst layer. Specifically, when Nafion (R) is used as the polymer electrolyte membrane, for example, it is possible to perform a hot pressing under a condition that a temperature is 135° C., a pressure is 10 kgf/cm², and a time period is 5 minutes (2 minutes for preheating, 3 minutes for pressing).

In the steps described above, when a porous substrate is used as the base, it is possible to manufacture membrane electrode assembly 1 formed by successively stacking catalyst layers 5a and 5b, extraction electrodes 6a and 6b, and porous substrates 7a and 7b at electrolyte membrane 2 in the example shown in FIG. 1, respectively, and integrating the same with electrolyte membrane 2. When a sheet made of PTFE is used as the base, it is possible to implement, by peeling off the PTFE-made sheet, the membrane electrode assembly formed by successively stacking the catalyst layer and the extraction electrode at the electrolyte membrane and integrating the same with the electrolyte membrane. These membrane electrode assemblies have a structure where the extraction electrode and the catalyst layer are adjacent and bonded, and hence a resistive loss can be made small, which makes it possible to provide a fuel battery having a favorable output characteristic.

In the integrating step (3), it is possible to use, instead of the electrolyte membrane, a Catalyst Coated Membrane (CCM) where a catalyst electrode is directly transferred to an electrolyte membrane in advance. By doing so, it is possible to form a catalyst layer having stability in strength. An example of the method of producing the CCM is a decal method. A slurry produced by a method similar to the above-described method is uniformly applied, by means of a bar coater or the like, to a sheet made of PTFE and serving as a carrier sheet, and is dried to remove the solvent, and then the carrier sheet is thermocompressed to the electrolyte membrane by a hot pressing method and is peeled off, so that the CCM can be produced. By integrating the electrode base material having the catalyst layer produced in the catalyst layer forming step (2), with this CCM through hot pressing, it is possible to manufacture membrane electrode assembly 11 having a structure in which first catalyst layers 14a and 14b, second catalyst layers 15a and 15b, extraction electrodes 6a and 6b, and porous substrates 7a and 7b are successively stacked, respectively, at electrolyte membrane 2 shown in FIG. 3.

At this time, by forming at the electrode base material a catalyst layer having a higher void ratio than the catalyst layer of the CCM has, it is possible to implement membrane electrode assembly 11 described above where first catalyst layers 14a and 14b have a higher void ratio than second catalyst layers 15a and 15b have. By doing so, it is possible to provide a membrane electrode assembly having a structure which improves fuel diffusivity in the catalyst layer located below the extraction electrode, and increases a total area of an effectively-operating, three-phase interface. Specifically, examples of a method of adjusting a void ratio include a method of increasing a void ratio by performing a drying process after the application of the slurry more drastically than usual in the catalyst layer forming step (2) to internally cause a crack, a method of mixing into the slurry a pore-forming material (e.g. a zinc powder, calcium carbonate, a commercially-available organic blowing agent, a commercially-available inorganic blowing agent or the like), and after drying the slurry, melting the pore-forming material with an acid, an alkali, water or the like to remove the same to form a void, a method of modifying a particle diameter and a specific surface area of the catalyst-carrying carbon, and other methods. As such, by allowing first catalyst layers 14a and 14b to have a higher void ratio than second catalyst layers 15a and 15b have in membrane electrode assembly 11, fuel diffusivity immediately below extraction electrodes 6a and 6b, and a product ejecting property are improved, and an area of the three-phase interface that does not function owing to fuel shortage is reduced, so that it is possible to provide a membrane electrode assembly with long lifetime and high output. Although a catalyst layer having a high void ratio is usually brittle, the extraction electrode serves as a core in the embodiment of the present invention, and hence it is possible to produce a catalyst layer having a prescribed thickness with a strength maintained.

Preferably, the integrating step (3) further includes a step of forming irregularities at least one of a surface of the catalyst layer and a surface of the electrolyte membrane, which surfaces are to be bonded together, as a pretreatment of the step of integrating the electrode base material with the electrolyte membrane. With such a pretreatment, an anchor effect is exhibited when the electrode base material and the electrolyte membrane are integrated, and hence intimate contact between the surfaces to be bonded is improved. Examples of the method of providing irregularities at the surfaces include a method of directly scratching the surfaces by means of a bar coater, a blasting treatment, and other methods.

The membrane electrode assembly in the present embodiment will hereinafter be described specifically with reference to examples, to which the present invention is not limited.

### EXAMPLE 1

For the base of each of the anode electrode and the cathode electrode, there was used a cellulosic porous substrate having a thickness of 0.6 mm (from Apex Silver Mines Ltd.). For the extraction electrode, there was used a 0.06φ, 150-mesh Ni mesh (from the Nilaco Corporation) coated with 1 μm of gold plating. The porous substrate and the extraction electrode were pressed at a pressure force of 10 kgf/cm² for 10 seconds to produce an electrode base material where the extraction electrode is fixed by being embedded in the porous substrate.

A slurry was produced by mixing a 46.5 wt % platinum (on the anode side, 1:1 platinum-ruthenium)-carrying carbon catalyst (from Tanaka Kikinzoku Kogyo), a 20 wt % Nafion solution (from Aldrich) and isopropanol, by means of an agitation mill using zirconia beads, at 500 rpm for 50 minutes, while the amounts of the Pt/C, the Nafion solution, and the organic solvent are adjusted to have distribution rates of 2 mg Pt/cm², 1.0 mg/cm², 60 mg/cm², respectively, with respect to an area of the electrode. The slurry was applied to a surface of the electrode base material where the extraction electrode was fixed, to occupy an area of 5 cm² by a screen printing method. The solvent was dried at a room temperature to form a catalyst layer.

The electrode base materials each having the catalyst layer produced thereon were hot-pressed at both surfaces of a Nafion membrane having a film thickness of 170 μm (from DuPont) at a temperature of 135° C. at a pressure of 10 kgf/cm² (2 minutes for preheating, 3 minutes for pressing) to produce a membrane electrode assembly.

Next, a fuel container was installed such that the entire surface of the membrane electrode assembly on the anode side was immersed into fuel, and the cathode side was opened to atmosphere. There was used a fuel container provided with a hole having an area slightly larger than that of the catalyst layer at one side surface. An outer periphery of an electric power generating portion on the anode side of the membrane electrode assembly and the fuel container were bonded together such that the hole and the center position of the catalyst layer on the fuel cell side of the membrane electrode assembly were matched, and were sealed for preventing leakage of liquid fuel, so that a single cell of a fuel battery was produced. With the use of a 3M methanol aqueous solution as fuel, electric power was generated under the load condition of 0.1 A/cm², and under the measurement condition of a room temperature of 34° C. and a humidity of 40%. The output voltage was 0.37 V.

### EXAMPLE 2

A membrane electrode assembly was produced in a manner similar to that of Example 1, except that a carbon paper having a thickness of 0.26 mm (GDL21AA from SGL Carbon AG) was used for the porous substrate of each of the anode electrode and the cathode electrode. When measured under the condition similar to that of Example 1, the output voltage was 0.39 V.

Furthermore, an alternating-current impedance of the entire cell was analyzed by means of an electrochemical analyzer (PGSTAT30 from AUTOLABO), so that a Cole-Cole plot was obtained under the load condition of a current density of 25 mA/cm². It is generally known that an intercept of a circular arc by a real axis on a high frequency side shows ohmic resistance, and the ohmic resistance was 0.090Ω. Note that the ohmic resistance is configured with a circuit including membrane resistance, electrode resistance, and contact resistance connected in series. It was known from document values that the membrane resistance was 0.045Ω, and it was known from actual measurement values that the electrode resistance was 0.025Ω, and hence it was considered that the contact resistance was 0.020Ω.

In contrast, for a comparative experiment, a membrane electrode assembly was produced in a manner similar to that of Example 1, except that the extraction electrode was not used, and that a carbon paper having a thickness of 0.26 mm was used as the porous substrate of each of the anode electrode and the cathode electrode. The membrane electrode assembly was embedded into a characterization cell (FC05-01SP-REF from Electrochem, Inc.) in a sandwiched manner, and its alternating-current impedance was measured under the load condition of 25 mA/cm², while a 3M methanol aqueous solution was delivered to an anode channel at a flow rate of 1.0 ml/min and air was delivered to a cathode channel at a flow rate of 300 ml/min. The result shows that the ohmic resistance was 0.070Ω. The actual measurement values of membrane resistance and electrode resistance were 0.045Ω and 0.005Ω, respectively, and hence the contact resistance was 0.020Ω.

From the results above, it is confirmed that the membrane electrode assembly according to the present invention attains contact resistance equivalent to that of the characterization cell from Electrochem, Inc., in which the MEA was sandwiched by carbon extraction electrodes and fixed by a pressing force with the use of a bolt and a nut from outside.

### COMPARATIVE EXAMPLE 1

A membrane electrode assembly was fabricated in a manner similar to that of Example 2, except that the slurry was applied to a surface of the electrode base material, which surface is opposite to the surface where the extraction electrode was fixed, to form a catalyst layer, and that the surface of the catalyst layer and the electrolyte membrane were integrated by hot pressing. When measured under the condition similar to that of Example 1, the output voltage was 0.30 V.

Comparison between Example 2 and Comparative Example 1 also shows that the membrane electrode assembly according to the present invention has excellent in electric power generating property.

### EXAMPLE 3

A membrane electrode assembly was fabricated in a manner similar to that of Example 1, except that a sheet made of PTFE and having a thickness of 0.3 mm was used for the base, and that the sheet made of PTFE was peeled off from the finished membrane electrode assembly. When measured under a condition similar to that of Example 1, the output voltage was 0.36 V, and a favorable result was obtained.

### EXAMPLE 4

A membrane electrode assembly was fabricated in a manner similar to that of Example 1, except that there was used a cellulosic porous substrate formed by applying a slurry, which was made of 10 w/t parts of Valcan XC-72 (from Cabot Corporation) as a carbon powder and 5 w/t parts of epoxy resin being mixed into 50 w/t parts of water as a diluent solvent by means of an agitation bead mill, to surfaces of the bases of the anode electrode and the cathode electrode by a screen printing method, and by drying the diluent solvent for 2 hours in a heat treatment device set at 60° C. to form a conductive adhesion layer thereon, and that an extraction electrode, which was a 0.06 φ, 150-mesh Ni mesh (from the Nilaco Corporation) coated with 1 μm of gold plating, was pressed onto the same surface of the conductive adhesion layer at a pressure force of 10 kgf/cm² for 10 seconds for fixing the same. When measured under a condition similar to that of Example 1, the output voltage was 0.39 V.

### EXAMPLE 5

A membrane electrode assembly was fabricated in a manner similar to that of Example 2, except that there was used an electrode base material allowed to have water repellency. The electrode base material was obtained by pressing an extraction electrode, which was a 0.06 φ, 150-mesh Ni mesh (from the Nilaco Corporation) coated with 1 μm of gold plating, onto the surface of carbon paper on the cathode side at a pressure force of 10 kg/cm² for 10 seconds for fixing the same, by applying a carbon black-dispersed liquid, which was made of 10 w/t parts of Valcan XC-72 (from Cabot Corporation) as a carbon particle and 5 w/t parts of PTFE being mixed into 100 w/t parts of water as a diluent solvent by means of an agitation bead mill, to the same surface of the extraction electrode, by placing the extraction electrode for 1 hour in a heat treatment device set at 120° C. to dry the coating, and by heating the extraction electrode in an electric furnace for 30 minutes at 360° C. When measured under a condition similar to that of Example 1, the output voltage was 0.40 V, and a favorable result was obtained.

### EXAMPLE 6

In the catalyst layer forming step, the electrode base material immediately after the application of slurry, was placed in a heat treatment device set at 85° C. to rapidly remove a solvent in the carbon layer, so that the first catalyst layer was formed. In addition, there was used CCM having the second catalyst layer, instead of the electrolyte membrane. The CCM was fabricated by uniformly applying the slurry to a sheet made of PTFE by means of a bar coater, drying and evaporating the solvent, then thermocompressing the sheet on each of the surfaces of a Nafion membrane having a thickness of 175 μm (from DuPont) at a temperature of 135° C., at a pressure of 10 kgf/cm², for 4 minutes (2 minutes for preheating, 2 minutes for pressing) by a hot pressing method, and peeling off the carrier sheet. At both of the surfaces of the CCM, the electrode base materials each having the catalyst layer formed thereon in the catalyst layer forming step were hot-pressed at a temperature of 135° C., at a pressure of 10 kgf/cm², for 5 minutes (2 minutes for preheating, 3 minutes for pressing) to form a membrane electrode assembly. The steps other than the one described above were performed in a manner similar to that of Example 5. In order to measure avoid ratio of the catalyst layer, one of the membrane electrode assemblies was impregnated with an embedding epoxy resin (from Okenshoji Co., Ltd) and subsequently dried at a room temperature for 12 hours, and had its central portion cut. The central portion was observed by means of a scanning electron microscope (JSM-5000 from JEOL Ltd.) at an accelerating voltage of 10 kV, and at 4000-fold magnification, to obtain cross-sectional SEM photographs of the first catalyst layer and the second catalyst layer. A void ratio was calculated by scanning these SEM photographs by a scanner, binarizing the photographs with the use of analysis software (Image-Pro PLUS from Planetron, Inc.), and performing image processing for calculating an area ratio. The void ratios of the first catalyst layer and the second catalyst layer were 42% and 35%, respectively. The output voltage, which was measured in a manner similar to that of Example 1, was 0.42 V, and a preferable result was obtained.

### EXAMPLE 7

A membrane electrode assembly was fabricated in a manner similar to that of Example 6, except that, as a pretreatment of the step of integrating the CCM and the electrode base material by hot pressing, a surface of the second catalyst layer on the CCM was scratched by a bar coater under model number 3. (from RK Print Coat Instruments Ltd.) being moved thereon from up to down once, and left to right once so as to provide lattice-like scoring. When the surface of the second catalyst layer was observed, prior to hot pressing, by means of a confocal scanning laser microscope, it was confirmed that there was obtained scoring having a maximum depth of 1 μm and a maximum line width of 2 μm, at a 0.31 mm spacing. The output voltage, which was measured in a manner similar to that of Example 1, was 0.42 V, and a favorable result was obtained. The output voltage after successive energization of 1000 hours was 0.41 V. From comparison with Example 6, it was confirmed that a stable output could be ensured.

It should be understood that the embodiments and examples disclosed herein are illustrative and not limitative in all aspects. The scope of the present invention is shown not by the description above but by the scope of the claims, and is intended to include all modifications within the equivalent meaning and scope of the claims.

1. (canceled)

2. A membrane electrode assembly formed by successively stacking a catalyst layer, an extraction electrode, and a porous base at an electrolyte membrane, and integrating the catalyst layer, the extraction electrode, and the porous base with the electrolyte membrane.

3. The membrane electrode assembly according to claim 2, wherein the extraction electrode has an opening portion, and at least one selected from the group consisting of the porous base and the catalyst layer penetrates into the opening portion.

4. The membrane electrode assembly according to claim 2, wherein the porous base has electrical conductivity.

5. The membrane electrode assembly according to claim 2, wherein the porous base has a water-repellent surface.

6. (canceled)

7. The membrane electrode assembly according to claim 2, wherein the extraction electrode is integrated with the catalyst layer with an adhesion layer interposed therebetween.

8. The membrane electrode assembly according to claim 2, wherein the catalyst layer is configured with a first catalyst layer and a second catalyst layer placed in an order allowing the first catalyst layer to be at a larger distance from the electrolyte membrane than the second catalyst layer is.

9. The membrane electrode assembly according to claim 8, wherein the first catalyst layer has a higher void ratio than the second catalyst layer has.

10. The membrane electrode assembly according to claim 2, wherein the extraction electrode contains at least one element selected from the group consisting of Ti, Au, Ag, Pt, Nb, Ni, Cu, Si, W and Al.

11. The membrane electrode assembly according to claim 2, wherein the extraction electrode is either of a metal mesh and a stamped metal plate each having a surface subjected to a conductive, corrosion-resistant treatment.

12. The membrane electrode assembly according to claim 2, wherein the extraction electrode is formed by any of an ink jet printing method, a CVD method, a vapor deposition method, a plating method, a sol-gel method, a sputtering method, and a screen printing method.

13. A fuel battery having the membrane electrode assemblies recited in claim 2 arranged in a plane direction and wired electrically.

14. An electronic device having the fuel battery recited in claim 13 mounted thereon.

15. A method of manufacturing a membrane electrode assembly, comprising the steps of:
forming an electrode base material by fixing an extraction electrode at one surface of a base;
forming a catalyst layer on the extraction electrode; and
integrating the electrode base material having the catalyst layer formed thereon with an electrolyte membrane.

16. The method of manufacturing the membrane electrode assembly according to claim 15, wherein the step of integrating the electrode base material having said catalyst layer formed thereon with the electrolyte membrane is a step of integrating the electrode base material having the catalyst layer formed thereon with a Catalyst Coated Membrane (CCM), which is the electrolyte membrane having a catalyst layer transferred thereto.

17. The method of manufacturing the membrane electrode assembly according to claim 15, wherein a porous base having a water-repellent layer formed at a surface to be joined to the extraction electrode is used as the base.

18. The method of manufacturing the membrane electrode assembly according to claim 15, wherein a porous base having a conductive layer formed at a surface to be joined to the extraction electrode is used as the base.

19. The method of manufacturing the membrane electrode assembly according to claim 15, wherein the method includes a step of forming irregularities at least one of a surface of the catalyst layer and a surface of the electrolyte membrane, both of the surfaces being to be bonded together, as a pretreatment of the step of integrating the electrode base material with the electrolyte membrane.

20. The membrane electrode assembly according to claim 2, wherein the porous base is non-conductive.

21. A fuel battery having a plurality of cells connected electrically, each of the plurality of cells being formed by successively integrating a plurality of catalyst layers and an extraction electrode with a single electrolyte membrane.

22. The membrane electrode assembly according to claim 7, wherein an adhesion layer is formed to be placed at a peripheral portion of the catalyst layer.
